(19) United States
(12) Patent Application Publication
(10) Pub. No.: US 2014/0081661 A1
(43) Pub. Date: Mar. 20, 2014

(54) METHOD AND SYSTEM FOR PHYSICAL THERAPY USING THREE-DIMENSIONAL SENSING EQUIPMENT

(71) Applicant: Home Team Therapy, Cambridge, MA (US)

(72) Inventors: Timothy Fu, Arlington, VA (US); Anil Ranawat, New York, NY (US); Ben Gelfand, Briarcliff Manor, NY (US)

(21) Appl. No.: 13/935,703

(22) Filed: Jul. 5, 2013

Related U.S. Application Data
(60) Provisional application No. 61/668,262, filed on Jul. 5, 2012.

(51) Int. Cl. G06F 19/00

(52) U.S. Cl. CPC G06F 19/3481; G06F 19/3418
USPC 705/3

(57) ABSTRACT

A system, method, and article of manufacture for facilitating the administration of physical therapy to a patient located remotely from a prescribing therapist in which a processing device instructions is adapted to providing to the patient an instructional exercise video(s) related to a prescribed exercise regimen; track in three dimensions movement of the patient's body or body parts using a motion sensing device when the movement is related to the prescribed exercise regimen; and provide information related to the movement to the prescribing therapist located at location remote from the patient.

### CROSS-REFERENCE TO RELATED APPLICATIONS

This application claims the benefit of U.S. Provisional Patent Application No. 61/668,262, filed Jul. 5, 2012 and entitled “Method and System for Physical Therapy Using Three-Dimensional Sensing Equipment,” which is incorporated herein in its entirety by reference.

### BACKGROUND OF THE INVENTION

A method and system for physical therapy is disclosed and, more particularly, a method and system that uses three-dimensional sensing equipment to provide a representation or image of some portion of the patient's body in three dimensions during performance of a physical therapy regimen to a remote third party.

One of the most widely administered prescriptions to address injuries and to aid in recovery from surgery is physical therapy. Typically, a patient is referred to a physical therapist who, based on the particular injury or procedure, designs a set of therapeutic exercises for the patient. These exercises may be completed at the therapist's office, often using state-of-the-art machines, and/or under the direct supervision of the therapist.

However, along with office visits, the routine is often supplemented with exercises to be completed by the patient at his home, without the benefit of the equipment or of the personal attention of the therapist. In such cases, the patient is commonly given a set of paper-based instructions that describe, usually in a rudimentary manner, the regimen he is to follow in between office visits. Typically, these paper protocols are not specific to each client's individual needs, and certainly not interactive. Moreover, with paper protocols there is no way for the prescribing therapist to check in on her patients to ensure compliance beyond the patient's recollection. From the patient's perspective, the paper instructions can be dull, unclear, and un-motivating, leading to a lack of compliance or even total disregard. This can result in incomplete or delayed recovery, as well as additional costs to the patient, his insurer, and his employer.

Several methods and systems for facilitating patients' adherence to physical therapy regimens have been designed in the past. Unfortunately, these approaches have many shortcomings that do not satisfy patient needs on several levels. Conventional patient interfaces typically involve the use of peripheral equipment that limits the number and type of exercises that can be performed. Some of these systems are designed for performing and monitoring physical therapy, in which the patient interface is a joystick or game controller. Unfortunately, the joystick or controller-based user interface limits the breadth of exercises that can be performed by a physical therapy patient. Other inventions utilize wireless sensors and controllers as a user interface. Despite their ability to track several points on the patient's body, these systems are not capable of fully representing the patient's body or body parts in three dimensions.

Some systems propose utilizing wireless controllers, video cameras, and/or other sensing devices for detecting heart rate and for pose tracking during exercise. However, these inventions fall short in that they do not recreate a three-dimensional representation of the patient during exercise, and, furthermore, do not provide feedback (either immediate or delayed) of the patient's performance to a third party, e.g., a caregiver, therapist, surgeon, athletic trainer, and so forth, who is located remotely from the patient.

What is needed, therefore, are techniques and supporting systems that track and record a patient's movements in three dimensions as they relate to a prescribed exercise regimen that can be monitored and/or coached remotely by another individual.

### SUMMARY OF THE INVENTION

The methods, techniques, and supporting system and apparatus supplement and, in some cases, replace current paper protocols used to administer physical therapy and exercise regimens by providing an interactive portal using online instructional videos and a three-dimensional motion sensing software application. The prescribed exercises are demonstrated on video, so that, while the patient is performing the exercises, his movements are tracked in three dimensions by a sensor. The physical therapist receives updates, e.g., contemporaneously or asynchronously, on some or all of the exercises completed by the patient and can also receive additional feedback from the patient on his progress, pain levels, and other exercise-related data.

The patient's performance of the exercises is captured on video using an infrared sensor, which is used to reconstruct a three-dimensional representation or image of the some portion of the patient's body or body parts, e.g., the hands, shoulder, upper body, lower extremities, and the like. This representation or image can be tracked in three dimensions, which provides real-time feedback to the patient, i.e., “user”, as well as detailed performance information to the user's coach or physical therapist. Advantageously, the user may be able to perform and track whole-body exercises, such as squats and lunges, which cannot be tracked using joysticks, keypads, or other similar user input devices.

Therefore, in a first aspect, a method for monitoring, administering and managing physical therapy and strength training captures a user's movements through a prescribed exercise and therapy regimen using a three-dimensional motion-sensing device. The regimen is presented to the user via an interactive user interface, e.g., a computer monitor, tablet computer, smartphone, gaming console or other similar device) as the user performs the therapeutic exercises. The presentation includes instructions on how to do the exercises, provides real-time feedback to patients (from, for example a coach, physician or therapist) during the exercise. In some instances, users engage in cooperative and competitive games, which increase motivation and add a social dynamic to the exercise regimen.

In some embodiments, physical therapists or other care providers provide patients with online video instructions demonstrating how to complete exercises. Patients then use the three-dimensional motion sensing software application as a guide through the workout while receiving real-time feedback on form, speed and other exercise parameters. The patients and their care providers can see their progress and provide encouragement and motivation. In embodiments in which social networking or collaborative usage is implemented, the user may be presented with a leaderboard showing the progress of other patients. After each workout, the patient may be prompted to electronically report subjective orthopedic injury scores to gauge progress. These data may be transmitted directly to the physical therapist and aggregated for epidemiological studies. Patients may also send messages, e.g., email, text, chat, and the like, to other caregivers with questions, progress toward milestones, and scheduling requests.

More specifically, in the first aspect of the present invention, a computerized method for facilitating the administration of physical therapy to a patient located remotely from a prescribing therapist is disclosed. The method comprises providing a memory(ies) storing computer-executable instructions and providing a processing unit for executing the instructions stored in the memory(is). Preferably, in some embodiments, execution of the instructions results in the processing unit providing the patient an instructional exercise video(s), e.g., instructional text and photographs) related to a prescribed exercise regimen; tracking in three dimensions movement of the patient's body or body parts using a motion sensing device when the movement is related to the prescribed exercise regimen; and providing information related to the movement to the prescribing therapist located at location remote from the patient.

In another embodiment the processing unit may maintain a record of which instructional exercise video(s) was watched by the patient and when. In still other embodiments, the processing unit may display a timer to inform the patient how long to perform an exercise. In yet another embodiment, the processing unit may display a questionnaire to the patient to record a self-diagnosed healing progress.

In a variation of some embodiments, the processing unit may perform the steps of sensing use of an elastic exercise band by the patient; sensing an elongation of the elastic exercise band to a certain distance; and calculating a force applied to the elastic exercise band by the patient. In other variations, the processing unit may monitor a physiological parameter(s) of the patient during exercise; generate feedback to the patient during exercise using the physiological parameters to estimate at least one of an exercise velocity, an exercise range of motion, an exercise posture, an exercise effort, and a force applied; store information related to a patient's compliance to the prescribed exercise regimen in a data storage device; record the information related to the patient's compliance to the prescribed exercise regimen, e.g., exercise compliance, subjective orthopedic scores, exercise velocity, exercise range of motion, exercise posture, exercise effort, and force applied during exercise, over time in a longitudinal study of patient activity and recovery speed as well as information related to when the patient completes the prescribed exercises, when the patient does not complete the prescribed exercises, when the patient reports pain during exercise, when the patient asks a question to the healthcare provider regarding the prescribed exercises, and when the patient requests a new appointment or cancels a previously scheduled appointment; aggregate the information related to the patient's compliance to the prescribed exercise regimen and producing statistical representations of aggregated patient outcomes, activity, and recovery speed; and compare the information related to the patient's compliance to the prescribed exercise regimen among a plurality of patients. For example, comparison may be based on gender, injury type, age, subjective orthopedic score, physical location, body mass index, weight, fitness level, identification of therapist, and prescribed exercise program.

In further variations, the processing unit may monitor may be adapted to save the information related to the patient's compliance to the prescribed exercise regimen to an electronic health record for the patient; track the information related to the patient's compliance to the prescribed exercise regimen and communicating attainment of patient goals to the patient and the therapist; determine patient outcomes and recovery speed based on the information related to the patient's compliance to the prescribed exercise regimen; determine an effectiveness of each exercise for a particular injury using aggregation of statistics related to patient outcomes; facilitate an exchange of electronic messages between patients and therapists; facilitate a contribution of comments from the patient regarding a particular therapist, exercise or exercise regimen; rate the therapist based on aggregated patient feedback data; delivering exercise instruction to the patient by a physical therapist or care provider via an online video and/or an audio conference; use patient's compliance and personal information to produce changes to the patient's exercise regimen and improve compliance; record a patient's mood and facial expressions during exercise using three-dimensional facial tracking; use a physics algorithm to read and record forces experienced in the patient's body during physical therapy exercise; and record a patient's heart rate during physical therapy exercise.

In a second aspect of the present invention, a system for facilitating the administration of physical therapy to a patient located remotely from a prescribing therapist is disclosed. In some embodiments, the system comprises memory for storing computer-executable instructions and a processing unit(s) for executing the instructions stored in the memory. Preferably, execution of the instructions results in the processing unit performing the steps of providing to the patient an instructional exercise video(s) related to a prescribed exercise regimen; tracking in three dimensions movement of the patient's body or body parts using a motion sensing device when the movement is related to the prescribed exercise regimen; and providing information related to the movement to the prescribing therapist located at location remote from the patient.

The system device may be a laptop, desktop, pad computer or mobile device, and use sensing devices such as Kinect device from Microsoft, Inc. or the Leap Motion device from Leap Motion, Inc. A server may be provided that stores regimen data and patient data. The server may also facilitate communication among the users and the therapists, whereas in some instances the communication may be implemented using peer-to-peer protocols. The instructions may be stored locally, e.g., on the computing device, as an application (or “app”) or stored remotely on a central server. In some instances, certain functions may be instantiated using client-resident instructions and other functions reserved for the server.

In a third aspect of the present invention, an article of manufacture for facilitating the administration of physical therapy to a patient located remotely from a prescribing therapist is disclosed. The article of manufacture comprises embedded computer-readable program portions for facilitating the administration of physical therapy. In some embodiments, the program portions comprises instructions for providing to the patient an instructional exercise video(s) related to a prescribed exercise regimen; tracking in three dimensions movement of the patient's body or body parts using a motion sensing device when the movement is related to the prescribed exercise regimen; and providing information related to the movement to the prescribing therapist located at location remote from the patient. In another aspect, a system for monitoring, administering and managing physical therapy and strength training is implemented using a computing device that includes physical memory devices for storing computer-executable instructions, and one or more processors for executing the instructions.

These techniques and systems provide patients with a fun, engaging, and effective tool for completing their prescribed physical therapy regimens, and provide physical therapists with a solution to treat patients that delivers more accurate patient exercise data, more usable patient outcomes data and higher quality of care.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 illustrates an exemplary online site map of the various pages within an application used to implement various embodiments of the invention.

FIG. 2 is an exemplary operational flowchart illustrating one method of implementing various embodiments of the invention.

FIG. 3 is an exemplary system diagram showing various components of a system for implementing various embodiments of the invention.

FIG. 4 is an exemplary website screenshot of one implementation of an embodiment of the invention.

FIG. 5 is another exemplary screenshot illustrating three-dimensional motion sensing in accordance with various embodiments of the invention.

### DETAILED DESCRIPTION

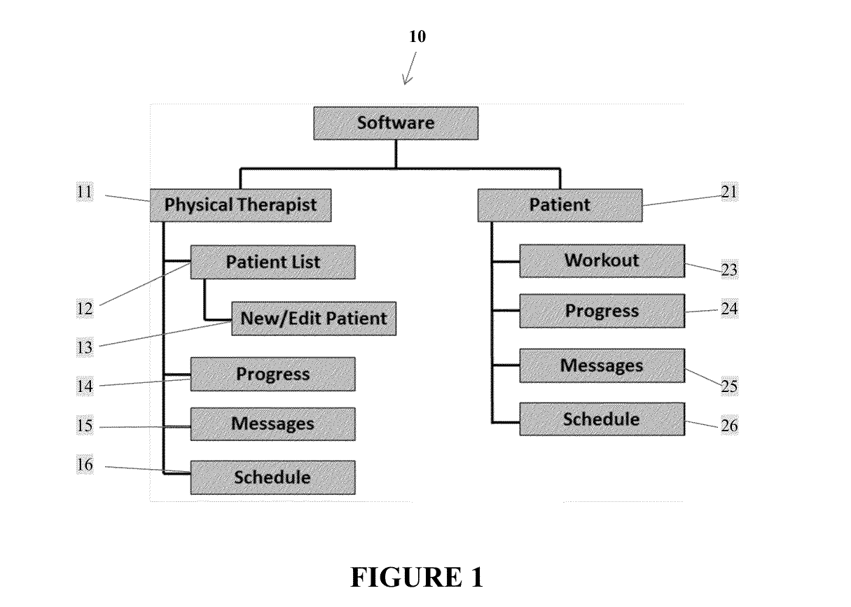

FIG. 1 shows an illustrative embodiment of an online site map 10 for describing a collection of web pages and user interfaces that can be used by physical therapists 11 and/or patients 21 to administer, for example, physical therapy, strength training, or general exercise regimens. While described herein as relating specifically to the administration of physical therapy, these same techniques may also be used by healthy or recovering athletes in general exercise and strength training programs.

In practice, a physical therapist 11 may log into a system, which is described in greater detail below, e.g., using a login ID and password. Once logged in and authenticated, the therapist 11 may be presented several web pages, which may allow her to view a patient list 12 (Patient List), to create new patient accounts or edit patient workouts 13 (New/Edit patient), to monitor patient progress 14 (Progress), to send messages to and receive messages from patients or to/from other care providers 15 (Messages), and to schedule new appointments, e.g., an in-person appointment, a virtual appointment, and the like, with patients 16 (Schedule). Both physical therapists 11 and patients 21 may also be able to comment on existing message threads and/or to “like” existing messages. Patients 21 and physical therapists 11 also may message their peers from the application, as well.

Patients 21 have access to analogous pages. For example, patients 21 may log into the system, e.g., using a login ID and password. Once logged in and authenticated, the patient 21 may watch instructional exercise videos 23 (Workout), view their activity and progress to-date 24 (Progress), send messages to and receive messages from their care providers 25 (Messages), and schedule new appointments with their physical therapist or surgeon 26 (Schedule). In some embodiments, the instructional exercise videos may feature a physical therapist 11 providing detailed instruction on how to perform each exercise, followed by a demonstration of that exercise by a patient or athlete. In addition to online instructional videos, patients 21 may print-out home exercise programs that describe exercises with text-based instructions and images.

Advantageously, patient activity may be tracked against a prescribed regimen, e.g., using event-based website analytics (not shown). The regimen may be patient-specific, generic, or some combination of generic exercises and custom exercises. For example, a patient's performance activities may be recorded and stored in a database, e.g., an analytics database. The analytics may be used to improve physical therapy exercise programs for that patient 21, other patients, as well as the application itself.

Optionally, once the patient 21 has completed his exercise regimen, he may complete a functional outcome or activity questionnaire in order to survey his progress. This survey may be conducted using a well-accepted orthopedic questionnaire, e.g., the Lysholm Knee Questionnaire, the Tegner Activity Scale, and so forth, to subjectively measure and record the patient's healing and recovery progress.

Patients 21 may compare their own activity, progress, and outcomes to other patients' progress within the application. These comparisons may be done on an aggregate basis, where the user 21 may be compared to a group of other users 21 whose data are compiled into one dataset, or on a user-by-user basis, in which the user 21 may be compared to another individual user 21. Comparative users may be chosen according to one or more demographic and/or medical parameters, such as, for example and not for the purpose of limitation, gender, injury, age, subjective orthopedic score, location/zip code, BMI, weight, fitness level, exercise activity, physical therapist or care provider, and/or prescribed exercise program. Those of ordinary skill in the art can appreciate that there exists a myriad of demographics/parameters for grouping user data for comparative purposes.

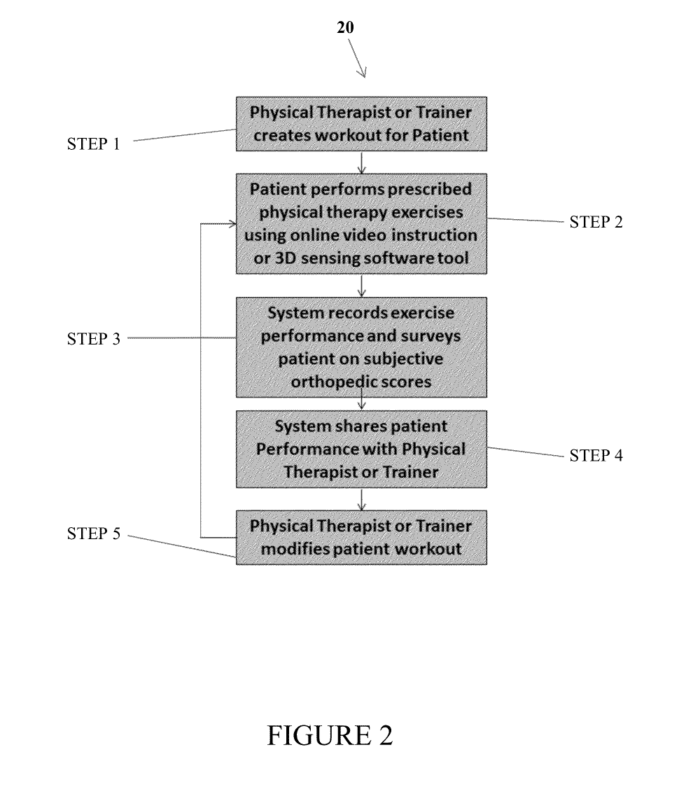

FIG. 2 shows an illustrative embodiment of an operational flowchart 20, describing an embodiment of the general operation of the system. Initially, a physical therapist 11 may create a new account and workout regimen for her patient 21 (STEP 1). To accomplish this step, the physical therapist 21 may create, import, and/or retrieve a therapeutic exercise regime for the discrete patient 21, to perform on a designated schedule, i.e., three days per week. In some embodiments, patients 21 may also create their own accounts and workouts or may suggest exercises to their therapists 11.

The patient 21 logs onto a website, e.g., using his personal login ID and password; watches instructional physical therapy videos, and/or opens a motion-sensing application on his home device. On the website, patients 21 may access a library of online exercise and other videos, which may be stored remotely, which are designed to guide patients 21 through each prescribed exercise. Both interfaces, which is to say the therapist's interface and the patient's interface, may be structured and arranged to record the patient's compliance with his exercise regime (STEP 2). For example, a patient's activity during performance of the exercise regimen may be recorded (STEP 3) and, when completed, reported to his physical therapist 11, trainer, surgeon, and the like (STEP 4). The patient's activity may include exercise compliance, subjective orthopedic scores, exercise velocity, exercise range of motion, exercise posture, exercise effort, force applied, and so forth. These data and/or scores may be stored and/or provided electronically to the therapist 11, to provide the therapist 11 with a clearer picture of her patient's progress and well-being. These data may also be tracked over time to determine a patient's recovery speed and progress. Optionally, once a patient 21 has completed his exercise regimen, he may complete a survey on several subjective measures related to his physical state, esteem, and performance during the physical therapy exercises.

With this information, the physical therapist 21, personal trainer, and the like may modify the patient's exercise regime (STEP 5). Once the patient's exercise program has been modified (STEP 5), the next time the patient 21 logs into the software application for the purpose of working through his regimen, he will have to perform a newly prescribed exercise regimen. The patient 21 may also compare his activity information to other users 21 or aggregated data from groups of users 21. These aggregated data may also be analyzed to help physical therapists 11 and trainers design more effective exercise programs for different types of injuries or strength training goals, as well as to gather feedback regarding specific therapists 11 and therapy regimens. For example, these data may enable physical therapists 11 and strength trainers to be ranked based on the effectiveness of their treatment and outcomes. Advantageously, such a tool may be used in marketing for therapists 21 and trainers to attract new clients.

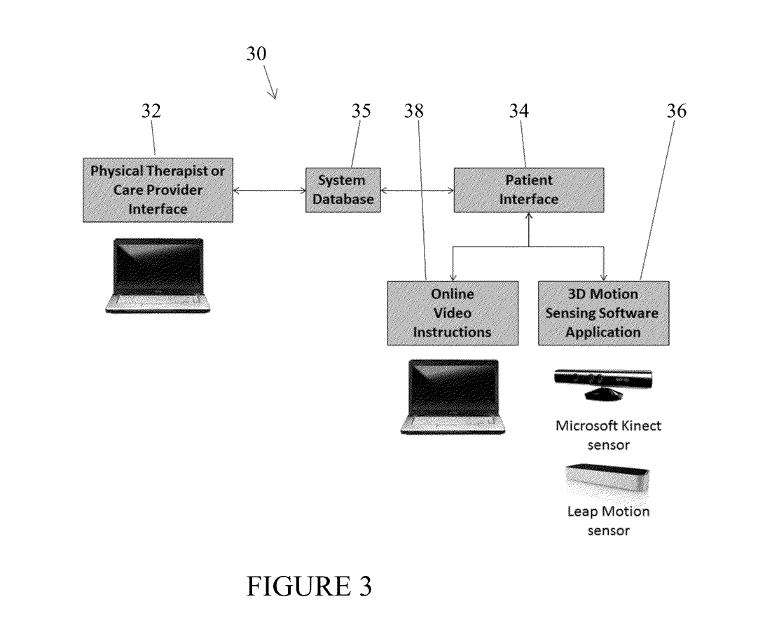

FIG. 3 shows an illustrative embodiment of a system 30 diagram that illustrates the relationship between the physical therapist's user interface 32 and the patient's user interface 34. These interfaces 32, 34 may be accessed, for example, by a personal computer, gaming console such as the Microsoft XBOX, mobile device such as the Apple iPad, computer tablet, cellphone, and so forth. The patient 34 and physical therapist interfaces 32 may be connected by a database 35 that is hosted on a server (not shown).

The therapist interface 32 may provide access to data relating to patient activity that has been stored in the database 35. The menu-driven interface 32 allows a therapist 21 to customize the patient's exercise routine, to monitor his progress, to exchange messages with the patient 21, and to schedule appointments that can occur virtually or in person. Advantageously, the system 30 may be adapted so that notifications may be sent to the therapist 21 automatically after any of the following events:
When the patient 11 completes the prescribed exercises;
When the patient 11 does not complete the prescribed exercises;
When the patient 11 reports pain during exercise;
When the patient 11 asks a question to the healthcare provider regarding the prescribed exercises;
When the patient 11 requests a new appointment.

Patient and physical therapist data may also be saved to the patient's personal health record. These data may be shared with healthcare providers, insurance payers, and so forth for the purposes of care, delivery, and billing.

The system 30 for implementing the techniques described above and for hosting the interfaces includes one or more clients, a data repository server, and query processing engine (collectively the “server”). The client is preferably implemented as software running on a personal or professional grade computer workstation, e.g., a PC with an INTEL processor or an APPLE MACINTOSH, capable of running such operating systems as the MICROSOFT WINDOWS family of operating systems from Microsoft Corporation of Redmond, Wash., the MACINTOSH OSX operating system from Apple Computer of Cupertino, Calif., and various varieties of Unix, such as SUN SOLARIS from SUN MICROSYSTEMS, and GNU/Linux from RED HAT, INC. of Durham, N.C., and the like. The client may also be implemented on such hardware as a smart or dumb terminal, network computer, wireless device, personal data assistant, information appliance, workstation, minicomputer, mainframe computer, or other computing device, that is operated as a general purpose computer or a special purpose hardware device solely used for serving as a client in the system 30.

The client includes client interface software that can be used, e.g., by a patient 11, a physical therapist 21, a personal trainer, and so forth, to create new exercise programs, to view instructional exercise videos 38, e.g., on a display device of a processing device, to perform exercises while being monitored by a three-dimensional sensor 36, to tracking patient activity, and the like; and that may be implemented in various forms, for example, in the form of a C# application that may be downloaded to the client and run in conjunction with a web browser. Alternatively, the client software may be in the form of a stand-alone application, implemented in a language such as Java, C++, C#, Visual Basic or in native processor-executable code. In one variation, if being executed on the client, the client software may open a network connection to the server over a communications network and communicate via that connection to the server.

The client may also include a three-dimensional motion sensing device 36 (“sensor”) and a related motion sensing software application(s). This type of sensor 36 has been implemented commercially as the “Kinect” sensor by Microsoft Corporation of Redmond, Wash., as the “PrimeSense” sensor by PrimeSense, LTD of Tel Aviv, Israel, and as the “Xtion” sensor by ASUS of Taipei, Taiwan.

Preferably, a communications network connects the clients with the server. The communication may take place via any medium such as standard telephone lines, local-area network or wide-area network links (e.g., T1, T3, 56 kb, X.25, and the like), broadband connections (e.g., ISDN, Frame Relay, ATM, and the like), wireless links, and so forth. Preferably, the network may be adapted to carry TCP/IP protocol communications, and HTTP/HTTPS requests made by client software and the connection between the client software and the server can be communicated over such TCP/IP networks. The type of network is not a limitation, however, and any suitable network may be used. Typical examples of networks that can serve as the communications network include a wireless or wired Ethernet-based intranet, a local-area network (LAN), a wide-area network (WAN), the global communications network known as the Internet, which may accommodate many different communications media and protocols, and the like.

The instructional exercise software and exercise tracking software may be adapted to provide instructions to the patient 11 and to record patient activity for review by the patient 11 himself, a physical therapist 21, a personal trainer, another healthcare provider, and the like. Patient data may be made anonymous and aggregated for the purpose of comparing or analyzing one patient's activity with regard to another patient(s) in the population. The algorithms which conduct this comparison and analysis provide the application processing component for this invention. This invention is preferably implemented on one or more server-class computers that have sufficient memory, data storage, and processing power and that run a server class operating system, e.g., SUN Solaris, GNU/Linux, MICROSOFT WINDOWS 2000, and later versions, or other such operating system. Other types of system hardware and software may also be used, depending on the capacity of the device, the number of patients/users, and the amount of data received. For example, the server may be part of a server farm or server network, which is a logical group of one or more servers. As another example, there may be multiple servers associated with or connected to each other or multiple servers may operate independently but with shared data. As is typical in large-scale systems, application software can be implemented in components, with different components running on different server computers, on the same server, or some combination.

The data repository server stores patient exercise and activity data, e.g., in a system database 35, being analyzed by the invention described herein. For instance, the data repository 35 may store information relating to products, documents, people, and/or transactions against which users submit search queries. Examples of databases that may be used to implement this functionality include the MySQL Database Server by Sun Microsystems, the PostgreSQL Database Server by the PostgreSQL Global Development Group of Berkeley, Calif., and the ORACLE Database Server offered by ORACLE Corp. of Redwood Shores, Calif.

The modules described throughout the specification may be implemented in whole or in part as a software program (or programs) operating on one or more processors using any suitable programming language or languages, e.g., C++, C#, Java, Visual Basic, LISP, BASIC, PERL, Python, HTML, CSS, Javascript, JQuery, and the like, and/or as a hardware device, e.g., ASIC, FPGA, processor, memory, storage, and the like.

The invention can be embodied in other specific forms without departing from the spirit or essential characteristics thereof. The foregoing embodiments are therefore to be considered in all respects illustrative rather than limiting on the invention described herein.

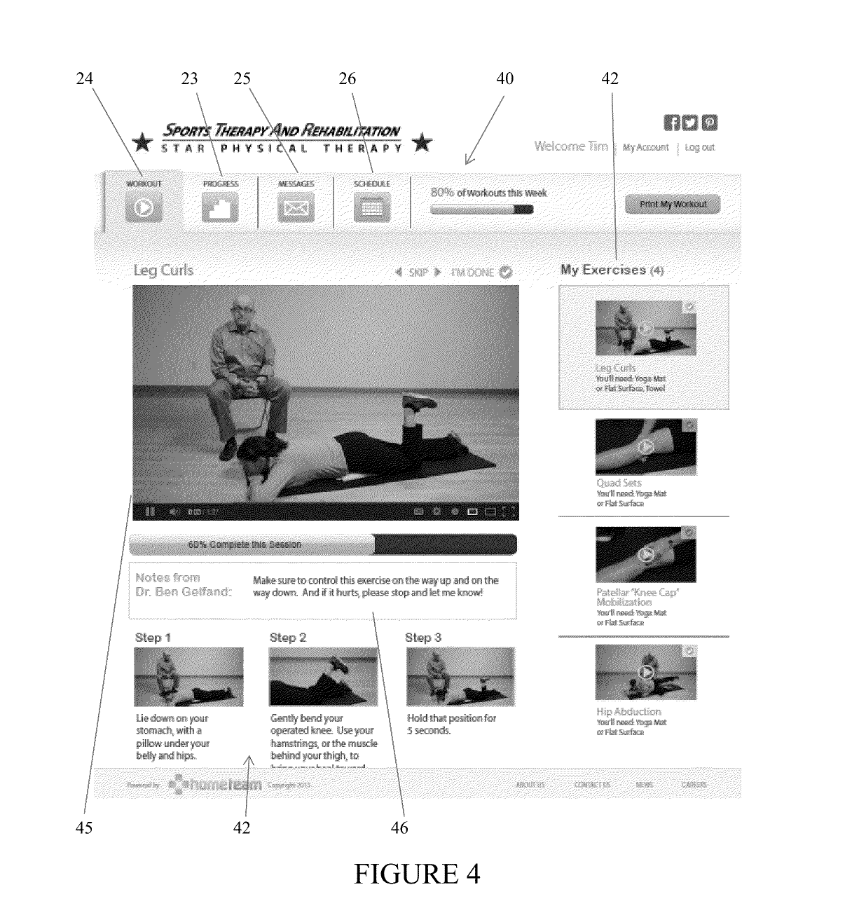

FIG. 4 shows some of the features of an exemplary schematic web interface 40 for patients 21. This patient-end web interface 40 allows patients 21 to watch, e.g., on an integrated display device 45, instructional physical therapy exercise videos that have been customized for each patient 21 in order to complete his prescribed physical therapy exercise(s) 42. Although the web interface 40 in FIG. 4 shows a personalized exercise regimen 42 that includes four exercises, i.e., leg curls, quad sets, patellar “knee cap” mobilization, and hip abduction, this is done for illustrative purposes only. Advantageously, the number and type of the exercises for a particular patient 21 will vary depending on the nature of the treatment.

Preferably, the web interface 40 may also include a written description, e.g., step-by-step instructions 42, of the exercise being shown in the video. Advantageously, several game-like tools may be used to motivate patients, including a leaderboard, reward systems, and so forth. A message board 46 may also be provided, for example, to enable the physical therapist 21, personal trainer, and the like to text messages to the patient 21, e.g., to encourage the patient 21, to provide additional guidance, to correct previously observed errors in performance of the exercise, and so forth.

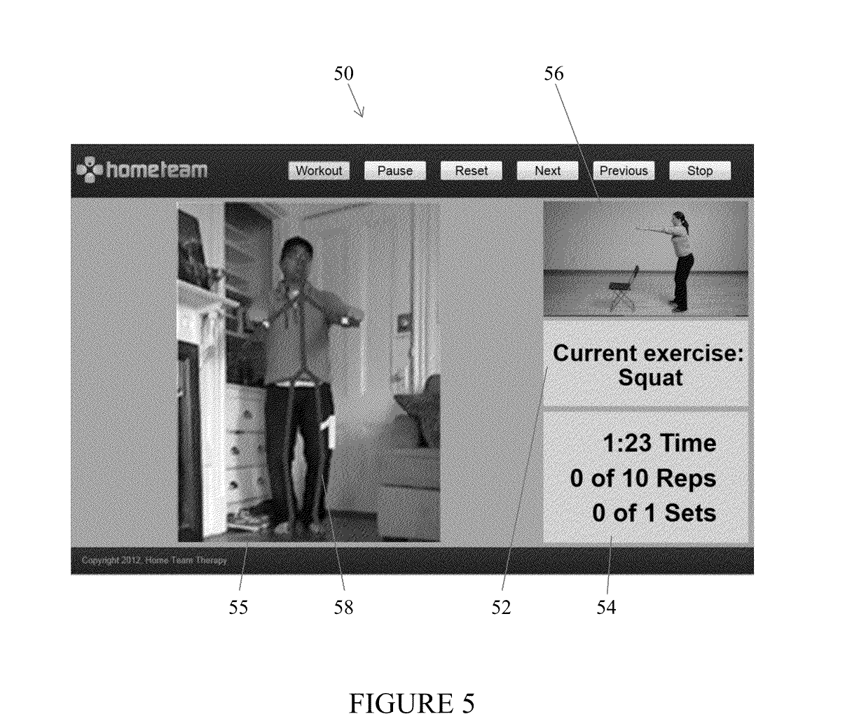

FIG. 5 shows some of the features of an exemplary schematic web interface 50 in which the display device 45 includes a screenshot 55 of a patient 21 performing an exercise 52, e.g., squats, that can be generated by a three-dimensional motion sensing software. The web interface 50 may include an identification of the exercise 52, a summary of the number of sets, repetitions, and time of exercise 54, and an image or short video of the exercise 56. In the center of the screenshot 55, an image of the user 21 doing the exercise is provided. Advantageously, the system 30 is adapted to superimpose a second image 58, e.g., a stick-figure, on the image of the user 21. The purpose of the second image 58 is to show the user 21 where each of his joints is positioned. The user 21 performs prescribed exercises and his progress is recorded by the three-dimensional motion sensing software.

Typically, physical therapy exercises begin from a resting position; progress to a target position (at which the exercise ends); and the return to the original resting position. They are inherently repetitive in nature. Each repetition may be captured by tracking the patient's pose as he performs the exercise. Once he reaches the target position, he is prompted to return to the resting position, and the repetition is counted. The patient's pose, range of motion, posture, speed, applied force, and other biometric data may all be tracked by this motion sensing device.

In addition to tracking the user's body, this application may track the user's application of force to an elastic band or strap. This may be accomplished in one of two ways, for example, via an electromechanical sensor or by sensing the elongation of that band in space and using a computer algorithm and Hooke's Law to calculate the force applied through the displacement of the elastic band.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments, and the various modifications that are suited to the particular use contemplated.

What we claim is:

1. A computerized method for facilitating the administration of physical therapy to a patient located remotely from a prescribing therapist, the method comprising:
providing at least one memory storing computer-executable instructions, and
providing at least one processing unit for executing the instructions stored in the memory, wherein execution of the instructions results in the at least one processing unit performing the steps of:
providing to the patient at least one instructional exercise video related to a prescribed exercise regimen;
tracking in three dimensions movement of the patient's body or body parts using a motion sensing device when the movement is related to the prescribed exercise regimen; and
providing information related to the movement to the prescribing therapist located at location remote from the patient.

2. The method according to claim 1, wherein the instructional videos comprise instructional text and photographs.

3. The method according to claim 1 further comprising the at least one processing unit maintaining a record of which of the at least one instructional exercise video was watched by the patient and when.

4. The method according to claim 1 further comprising the at least one processing unit displaying a timer to inform the patient how long to perform an exercise.

5. The method according to claim 1 further comprising the at least one processing unit of displaying a questionnaire to the patient to record a self-diagnosed healing progress.

6. The method according to claim 1 further comprising the at least one processing unit performing the steps of:
sensing use of an elastic exercise band by the patient;
sensing an elongation of the elastic exercise band to a certain distance; and
calculating a force applied to the elastic exercise band by the patient.

7. The method according to claim 1, further comprising the at least one processing unit monitoring at least one physiological parameter of the patient during exercise.

8. The method according to claim 7, further comprising the at least one processing unit generating feedback to the patient during exercise using the physiological parameters to estimate at least one of an exercise velocity, an exercise range of motion, an exercise posture, an exercise effort, and a force applied.

9. The method according to claim 1 further comprising the at least one processing unit storing information related to a patient's compliance to the prescribed exercise regimen in a data storage device.

10. The method according to claim 9, further comprising the at least one processing unit comparing the information related to the patient's compliance to the prescribed exercise regimen among a plurality of patients.

11. The method according to claim 10, wherein the at least one processing unit bases the comparison on at least one of: gender, injury type, age, subjective orthopedic score, physical location, body mass index, weight, fitness level, identification of therapist, and prescribed exercise program.

12. The method according to claim 9 further comprising the at least one processing unit recording the information related to the patient's compliance to the prescribed exercise regimen over time in a longitudinal study of patient activity and recovery speed.

13. The method according to claim 9 further comprising the at least one processing unit aggregating the information related to the patient's compliance to the prescribed exercise regimen and producing statistical representations of aggregated patient outcomes, activity, and recovery speed.

14. The method according to claim 9, wherein the information related to the patient's compliance to the prescribed exercise regimen includes at least one of exercise compliance, subjective orthopedic scores, exercise velocity, exercise range of motion, exercise posture, exercise effort, and force applied during exercise.

15. The method according to claim 9 further comprising the at least one processing unit saving the information related to the patient's compliance to the prescribed exercise regimen to an electronic health record for the patient.

16. The method according to claim 9, wherein the information related to the patient's compliance to the prescribed exercise regimen comprises information related to when the patient completes the prescribed exercises; when the patient does not complete the prescribed exercises; when the patient reports pain during exercise; when the patient asks a question to the healthcare provider regarding the prescribed exercises; and when the patient requests a new appointment or cancels a previously scheduled appointment.

17. The method according to claim 9, further comprising the at least one processing unit tracking the information related to the patient's compliance to the prescribed exercise regimen and communicating attainment of patient goals to the patient and the therapist.

18. The method according to claim 9 further comprising the at least one processing unit determining patient outcomes and recovery speed based at least in part on the information related to the patient's compliance to the prescribed exercise regimen.

19. The method according to claim 1 further comprising the at least one processing unit determining an effectiveness of each exercise for a particular injury using aggregation of statistics related to patient outcomes.

20. The method according to claim 1 further comprising the at least one processing unit facilitating an exchange of electronic messages between patients and therapists.

21. The method according to claim 1 further comprising the at least one processing unit facilitating a contribution of comments from the patient regarding a particular therapist, exercise or exercise regimen.

22. The method according to claim 1 further comprising the at least one processing unit rating the therapist based on aggregated patient feedback data.

23. The method according to claim 1 further comprising the at least one processing unit delivering exercise instruction to the patient by a physical therapist or care provider via at last one of online video and audio conference.

24. The method according to claim 9 further comprising the at least one processing unit using patient's compliance and personal information to produce changes to the patient's exercise regimen and improve compliance.

25. The method according to claim 1 further comprising the at least one processing unit recording a patient's mood and facial expressions during exercise using three-dimensional facial tracking.

26. The method according to claim 1 further comprising the at least one processing unit using a physics algorithm to read and record forces experienced in the patient's body during physical therapy exercise.

27. The method according to claim 1 further comprising the at least one processing unit recording a patient's heart rate during physical therapy exercise.

28. A system for facilitating the administration of physical therapy to a patient located remotely from a prescribing therapist, the system comprising:
at least one memory storing computer-executable instructions, and
at least one processing unit for executing the instructions stored in the memory, wherein execution of the instructions results in the at least one processing unit performing the steps of:
providing to the patient at least one instructional exercise video related to a prescribed exercise regimen;
tracking in three dimensions movement of the patient's body or body parts using a motion sensing device when the movement is related to the prescribed exercise regimen; and
providing information related to the movement to the prescribing therapist located at location remote from the patient.

29. An article of manufacture for facilitating the administration of physical therapy to a patient located remotely from a prescribing therapist, the article of manufacture comprising computer-readable program portions embedded thereon for facilitating the administration of physical therapy, the program portions comprising instructions for:
providing to the patient at least one instructional exercise video related to a prescribed exercise regimen;
tracking in three dimensions movement of the patient's body or body parts using a motion sensing device when the movement is related to the prescribed exercise regimen; and
providing information related to the movement to the prescribing therapist located at location remote from the patient.
